(19) United States
(12) Patent Application Publication
(10) Pub. No.: US 2024/0268288 A1
(43) Pub. Date: Aug. 15, 2024

(54) CONTINUOUS CULTIVATION OF PLANTS

(71) Applicant: Saia Holding B.V., Wageningen (NL)

(72) Inventors: Ruud Barth, Driebergen-Rijsenburg (NL); Bart Adrianus Johannes van Tuijl, Doesburg (NL)

(21) Appl. No.: 18/569,386

(22) PCT Filed: Jul. 12, 2022
(86) PCT No.: PCT/EP2022/069427

§ 371 Date: Dec. 12, 2023

(30) Foreign Application Priority Data
Jul. 13, 2021 (NL) 2028714

(51) Int. Cl. A01G 31/02; A01G 17/04; A01G 29/00

(52) U.S. Cl. CPC A01G 31/02; A01G 17/04; A01G 29/00

(57) ABSTRACT

A method of cultivating plants includes suspending a plant, where step of suspending includes freely hanging the plant by a top portion of a stem and where a root portion freely hangs from the stem in a substantially enclosed root compartment in the absence of growth medium, providing water with nutrients and/or oxygen to the root portion, lowering the plant after growth by re suspending of the plant by a newly grown portion of the stem above the top portion of the stem, and where, after the step of lowering, a bottom portion of the stem becomes freely hanging in the root compartment, to allow new roots to grow on the bottom portion of the stem in the root compartment, pruning the root portion at least partially at a bottom end thereof, and repeating the steps of lowering and root pruning after each time the plant has been allowed to grow.

### CROSS-REFERENCE TO RELATED APPLICATIONS

This application is the National Stage of International Application No. PCT/EP2022/069427, filed Jul. 12, 2022, which claims the benefit of Netherlands Application No. 2028714, filed Jul. 13, 2021, the contents of which is incorporated by reference herein.

### FIELD OF THE INVENTION

The present invention relates to a method of cultivating plants, e.g. of cultivating plants in a greenhouse, in a continuous manner. The present invention further relates to a cultivation assembly, a root growth promotor and an indoor farm for mobilized plants.

### STATE OF THE ART

During normal growth of plants, in particular plants in greenhouse cultivation, like tomato, bell pepper, cucumber and eggplants, a length of the plant's stem increases over time. A newly-grown part of the plant typically grows leaves and produce at certain points along the stem, but the stem itself also continues to grow, so that when this produce is harvested, new stem is grown above the harvested produce. As a result, the length of the stem between the plant's root portion and the produce increases over time, resulting in efficiency losses and eventually will result in the plant stopping producing. Hence, it requires more energy for the plant to transport nutrients from the root portion to the produce, and it has impracticalities, i.e. the excess stem needs to be accommodated in the greenhouse.

Prior art PCT-application WO 01/97599 A2 thereto discloses a cultivation system comprising a movable support wire extending in loop, which is configured to be fastened to the plant. The plant is guided by the support wire, having its stem substantially upright and having its root portion lying in a watering tube. During growth of the plant, the support wire moved, so that the stem is lowered and that an excess part of the root portion becomes lying in an upwardly-tilted part of the watering tube. This upward tilting forces any hormones towards the newly-lowered and horizontal part of the stem under influence of gravity, and eventually becomes projecting out of the watering tube with its bottom end, i.e. containing the oldest roots. This allows the stem to grow further along the vertical part of the support wire, allows a bottom portion of the stem to develop new roots in the watering tube and allows the excess root portion to be pruned, e.g. to be cut-off. In this way, the net length of the plant, i.e. containing the stem and the root portion, remains substantially constant, effectively resulting in continuous renewal of the plant.

A second example of such a continuous-growth cultivation system is disclosed in Jan Janse et. al., Ontwikkeling continuteelt komkommer (2005), Praktijkonderzoek plant en omgeving, Wageningen U R. This scientific publication discloses a similar system, in which a cucumber plant is partly suspended from a roof of a greenhouse, and in which roots of the plant are partly suspended in and from a spraying gutter in which they are held in an arc-shape whilst being sprayed. Also in this disclosure, a bottom end of the root portion is held upward, so that hormones flow downward in the arc, i.e. in a direction towards the stem.

However, these known assemblies have the drawback that it is relatively complex as a result of the horizontal watering tube and the support wire loop, which are both relatively voluminous, e.g. compared to the conventional cultivation systems. Secondly, the systems have several moving parts, in particular for the support line guiding and movement mechanism. This makes the known assemblies difficult to install in existing greenhouses. Furthermore, these systems are manually labour intensive to lower the plant and to cut the root portion.

In SE 424 399 B, a cultivation method is disclosed in which plants are suspended and of which the roots are suspended in an enclosed channel, in which they are sprayed. The channel comprises a plurality of top openings, through which the stems of the plants can extend during growth of the plant. Furthermore, this prior art document teaches that that plants could initially be cultivated in a conventional manner, having its roots arranged in soil, i.e. in a moisture absorbing ball. Only after a certain period of time, the plants can be placed with their root portions in the enclosed channel. Moreover, the positions of the plants are strictly confined in this existing cultivation method, by the top openings in the enclosed channel, and two dedicated spraying nozzles are provided for each of the plant positions to provide water and nutrients to the plants.

### OBJECT OF THE INVENTION

It is therefore an object of the invention to provide a cultivation method and assembly that is more convenient to operate and install than existing methods and systems, or at least to provide an alternative cultivation method and assembly.

### DETAILED DESCRIPTION

The present invention provides a method of cultivating plants, e.g. of cultivating plants in a greenhouse, the method comprising the steps of:
suspending a plant, which plant comprises a stem and a root portion,

wherein step of suspending comprises freely hanging the plant by a top portion of the stem and wherein the root portion hangs from the stem, e.g. freely hangs from the stem, in a substantially enclosed root compartment in the absence of growth medium,
providing water, e.g. with nutrients and/or oxygen to the plant, i.e. to the root portion, in the root compartment,
lowering the plant after having allowed the plant to grow,

wherein the step of lowering comprises the re-suspending of the plant by a newly-grown portion of the stem, i.e. above the top portion of the stem, and wherein, after the step of lowering, a bottom portion of the stem becomes freely hanging in the root compartment, to allow new roots to grow on the bottom portion of the stem in the root compartment,
pruning the root portion at least partially at a bottom end thereof, and
repeating the steps of lowering and root pruning after each time the plant has been allowed to grow.

The method is configured to grow plants continuously and substantially straight and vertically, so that a length of the plant, i.e. of the stem, is substantially the same after each time the plant is lowered, i.e. lowered partially into the root compartment. This method is in particular efficient in greenhouse cultivation, where a roof structure of the greenhouse is present above the plants, from which the plants can be suspended. The plants may, for example, be suspended from a wire, such as a metal wire, or any other support structure.

The plants cultivated in the present method comprise a stem and a root portion. The stem of the plant can thereby be defined as the part of the plant that is substantially free of roots and rather has produce and leaves attached to it, whereas the root portion may defined as the part comprising roots, e.g. typically being formed on a former bottom portion of the stem that previously contained produce, leaves and side shoots, which have been pruned off and which now develops root growth, e.g. under the influence of certain conditions like humidity, low light level and oxygen level.

The root portion is located In the root compartment when the method is carried out, whereas the stem is located outside, e.g. above, the root compartment. The present method is in particular effective for the cultivation of plants with a stem that is relatively long compared to the length of the plants root portion, like tomato plants, bell pepper plants, cucumber plants and/or eggplants, and plants the like that are able to form roots on stem parts under certain conditions like humidity, low light level and oxygen level.

Opposed to the existing methods, the plants are freely suspended in the present method. This implies that substantially the entire plant hangs under the influence of gravitational forces, i.e. thus hanging substantially vertical, without resting at least partially horizontally and without being arranged in any type of root growth medium and preferably without the root portion being supported separately by a root compartment.

The plant is held at a top portion, for example being held at one or more points at a top portion of its stem. The top portion of the stem may be defined as the upper 25% of the stem in terms of height. However, the plant not needs to be held exclusively at the top portion and may for example be held additionally at a middle portion and/or a bottom portion.

The free suspension of the plant yields that the plant substantially fully supports its own weight. Hence, all parts of the plant below the top portion, e.g. a middle and bottom portion of the stem and at least part of the root portion, are fully hanging from the top portion, without being substantially supported otherwise in the vertical direction.

The root portion of the plant is suspended in the root compartment, preferably being freely suspended, so that also the root portion is fully suspended from the stem, without being supported otherwise. The root compartment is substantially closed-off from the surroundings, for example only comprising a single opening at a top end through which the plant may extend. The root compartment is substantially empty, which implies that the plant's roots are not arranged in any type of growth medium, like soil, rock wool or the like, but instead that the plant's roots freely hang in the air inside the root compartment. The root portion of the plant may hang vertically in the root compartment. However, in case the length of the root portion is relatively long compared to the height of the root compartment, the bottom portion of the root portion may be tied up to the plant stem, to prevent the root portion from contacting the bottom of the root compartment.

In the root compartment, water with nutrients may be supplied to the plant's roots. This supply of nutrients may involve supplying water, i.e. combined with nutrients, oxygen and fertilizer etc., so that they can be absorbed by the roots. The supplying may involve spraying of water with nutrients onto the root portion, wherein the spraying may rely on droplets with various sizes, varying from a small droplet size, in which the spraying effectively becomes misting or generation of a fog, to a large droplet size, for example to effect a certain degree of direct penetration of the plant with water. In an embodiment, the size, i.e. diameter, of the droplets may be in the range between 20 μm to 80 μm.

Alternatively, the watering may involve submerging, in particular temporarily submerging, of the root portion in a body of water with nutrients. In addition to the submerging, oxygen may be actively fed into the body of water, for example by means of bubbling, to provide for additional oxygen and turbulence to the submerged root portion. As a further alternative, the watering may involve dripping of the root portion, for example by discharging droplets of water into an inner volume of a root growth promotor that is filled with the root portion.

The plant is allowed to grow under influence of the nutrients and for example under exposure of light. During growth, the plant may form a newly-grown portion of stem above the top portion, which original top portion thereby becomes a former top portion and which newly-grown portion then becomes the top portion. The growth may further concern growth of the root portion inside the root compartment, for example in terms size of the roots and/or by the formation of new roots, and may concern growth of produce, leaves and side shoots.

After having allowed the plant to grow, the length of the stem will be increased. To hold the stem length substantially constant, the plant is lowered after it has grown to a certain extent. By lowering, it is meant that the plant's suspension is changed, so that the plant will hang lower. Accordingly, a bottom portion of the root portion is pruned.

After the step of lowering, a bottom portion of the stem becomes freely hanging in the root compartment, i.e. being suspended from the part of the plant's stem located above the root compartment. Hence, the root compartment will not be lowered together with the plant, thus remaining substantially stationary. After lowering, the bottom portion of the stem and the original root portion together become the new root portion and a new bottom portion of the stem is defined just above the root compartment.

The original bottom portion of the stem, which now becomes arranged in the root compartment, will be subjected to the water, e.g. with the nutrients and/or oxygen and will thereby develop new roots. Hence, the plants may develop new roots automatically where the environment is moist and where the level of light, i.e. the light intensity, is relatively low. In particular, new roots may form in darkness, i.e. in the absence of light.

After lowering and having waited for a certain period of time, the original bottom portion of the stem, i.e. with its new roots, will form, together with the plant's original root portion, the root portion inside the root compartment. It is remarked that the definition of which part of the plant belongs to the root portion thus changes each time the plant is lowered.

The lowering of the plant concerns the releasing of the plant from its original suspension, i.e. in which it was suspended from its original top portion. After release, the plant is lowered and suspended again. However, the plant is now suspended at least partly by its newly-grown portion, i.e. the portion of the plant's stem above the original top portion. As a result, this newly-grown portion then, by definition, becomes the top portion of the stem. It is noted that not the entire plant necessarily becomes suspended by the newly-grown portion, but that the plant may also be suspended by both the newly-grown portion and the original top portion in combination.

The pruning is carried out to prevent the root portion from becoming too large inside the root compartment. Hence, after lowering, the length of the plant's part inside the root compartment becomes larger. Accordingly, the pruning concerns the cutting of a bottom portion of the root portion, so that the length of the new root portion is substantially the same as the length of the original root portion, i.e. before lowering.

The pruning may be carried manually or automatically, but is, within the meaning of the present invention, always carried out as an active step during which part of the root portion is removed. This active step differs, for example, from the prior art growing method, in which a bottom portion of the roots was supposed to die off, i.e. in the absence of water, and only being cut off afterwards.

Finally, these steps are repeated, i.e. allowing the plant to grow while supplying the water, followed by lowering and root pruning. In this way, the plant is allowed to continuously ‘refresh’ itself, while having a length, e.g. a combined length of the stem and the root portion, that is substantially the same each time the plant is lowered and pruned. Alternatively, however, the plant may be kept at a certain length that suits current and/or future plant needs. This length may vary over time, for example because of seasonal effects, and may be selected for each repetition of the steps.

The present invention provides the advantage that the footprint of the plant can be significantly smaller than that of the plants in the prior art, as a result of the plant hanging fully vertical, instead of having a horizontal component. As a result of this smaller footprint, the risk of entanglement of roots of two adjacent plants is minimized, because each root portion is only located below the stem and not extending sideways substantially.

The invention provides the surprising benefit that it is not essential to have the root portion in contact with growth medium, or even with water as in the hydroponic cultivation in the prior art method.

The ability to grow without growth medium enables that the plants can be freely suspended, so that they substantially fully support their own weight. If a plant were to grow in growth medium, this free suspension would be very difficult, since the plant's stem will likely not be capable of carrying the additional weight of the growth medium and the growth medium will need constant replenishment each cycle the plant is lowered.

The present invention is furthermore counterintuitive for the skilled person, since the prior art document cited above teaches that the hormones will flow under the influence of gravity and that the lower end of the root portion will die off. With this prejudice, the skilled person would never hang a plant vertically by its own weight, because they would assume that would result in accumulation of hormones at the bottom end due to gravity. The present inventors have surprisingly found that this gravity-based lowering of hormones does not occur in the present invention.

However, the main advantage of the plants being suspended vertically by their own weight, is that they can be transported through the surroundings, e.g. the greenhouse, with great convenience. Hence, the plants only hang straight below a support structure and have free hanging root portions that are not located in voluminous and heavy plant pots or substrates.

Furthermore, the plants are not attached to the root compartment, but solely hang therein. Preferably the root portion substantially freely hangs in the root compartment, but alternatively part of the root portion may lie on a bottom wall of the root compartment. In the absence of such attachment, it is thus not necessary, when it is desired to move the plant around, to undo a support of the root portion inside the root compartment or to uncouple the root portion from a loop wire extending through the root compartment, like in the prior art. Instead, the plant's support structure can be moved simply, for example via a rail system, trolley and/or motorized carriage, whereas the root portion will move out of the root compartment and whereas the plant will thus follow movements of the support structure.

Moreover, the method according to the present invention cultivates plants in the absence of growth medium around the root portion throughout substantially the entire life cycle of the plants. Hence, the plant seeds are initially inserted in vermiculite to initiate root growth. However, as soon as roots starts to develop, the seeds are removed from the vermiculite and arranged in the root compartment. This differs from the existing cultivation methods, in which plant seedlings are initially cultivated in soil, i.e. in a moisture absorbing ball, and in which the soil is only removed at a later stage. This may provide the benefit that the present method may result in fewer waste, since no soil or other growth medium is utilized. Furthermore, the present method may provide for less stress for the plants, since they are no longer subjected to a change in conditions, i.e. from cultivation in soil to soilless cultivation.

Finally, the present method may rely on fewer spraying nozzles than in the existing cultivation method. Hence, according to the present invention, the plant positions not necessarily need to be defined at discrete, fixed positions. Instead, the plant positions may vary and each spraying device may have a relatively wide spraying range, thereby being able to spray multiple different plants inside the root compartment. In essence, the present invention uncouples the position of the plants and the spraying devices, which offers an improved flexibility of the cultivation system, allowing use for multiple different types of plants, and offers mobility for the plants.

In an embodiment, the method further comprises, after having allowed the plant to grow, e.g. before the step of lowering, the step of harvesting horticultural produce from the stem. The step of repeating thereby comprises repeating the steps of harvesting, lowering and root pruning.

According to this embodiment, the produce is harvested in each cycle of lowering and root pruning, since the produce typically also grows when the plant's stem is allowed to grow. Similarly, any leaves and side shoots may be cut from the plant's stem when the produce is harvested. Hence, these leaves and side shoots would otherwise absorb nutrients, therefore reducing the yield of the plant.

Alternatively, however, the harvesting does not take place during each of the repetitions. This may be the case when the growing duration of the plant, e.g. to reach a threshold level of the stem growth for a certain cycle, is shorter than a growing and/or ripening duration of the produce.

In an embodiment of the method, the step of suspending further comprises the clamping of the top portion of the stem with at least one clamp of a support structure. The at least one clamp may for example comprise two or three clamps, located above one another, which together hold the top portion of the plant.

The benefit of having clamps is that they may securely hold the plant, as the entire weight of the plant is hanging from them, while it is avoided that a flow of nutrients in the plant becomes blocked. Furthermore, the clamps may be relatively convenient to attach, for example by a human worker or a robot, so that the suspending of a plant can be carried out efficiently.

In a further embodiment of the method, the step of lowering comprises the releasing of the at least one clamp and the re-clamping of the newly-grown portion of the stem with the at least one clamp.

The lowering may thereby involve the release of the clamps at their original location at the original top portion of the plant's stem, the lowering after release, and the clamping at a new location of the plant's stem, namely at the newly-grown portion above the original top portion.

According to this embodiment, provided that the clamping is carried out with multiple clamps, one of the clamps may clamp the newly-grown portion of the stem, whereas another one of the clamps may still clamp the original top portion of the stem, but instead a higher part thereof. Alternatively, however, both clamps may end up clamping the newly-grown portion of the stem after lowering.

In an embodiment of the method, the step of providing water comprises the spraying of water, e.g. with nutrients and/or oxygen onto the plant in the root compartment.

A spraying device may thereby be provided inside the root compartment, which is configured to spray water onto the root portion. The spraying of the root portion may be sufficient for subjecting the root portion to its required amount of water and may make it obsolete to submerge the root portion in water. The spraying may rely on droplets with various sizes, varying from a small droplet size, in which the spraying effectively becomes misting or generation of a fog, to a large droplet size, for example to effect a certain degree of direct penetration of the roots with water. In an embodiment, the size, i.e. diameter, of the droplets may be in the range between 20 μm to 80 μm.

A further benefit of the spraying is that a mist of water may become present in the root compartment and that the humidity inside the root compartment may be higher than in the surroundings, i.e. the surroundings of the plant's stem, outside the root compartment. This higher humidity may promote the formation of new roots at the bottom portion of the plant stem, which has just been lowered into the root compartment, and may also promote the growth of existing roots of the root portion.

In an embodiment of the method, the spraying may comprise spraying multiple plants with a single spraying device. The method according to this embodiment can rely on fewer spraying nozzles than in the existing cultivation method. Hence, according to the present embodiment, the plant positions not necessarily need to be defined at discrete positions. Instead, the plant positions may vary and each spraying device may have a relatively wide spraying range, thereby being able to spray multiple different plants inside the root compartment.

In an embodiment of the method, the spraying of water is carried out intermittently for a spraying duration, and wherein subsequent spraying actions are separated by a pause duration.

According to this embodiment, the spraying is not carried out continuously, but instead during certain discrete spraying intervals. The spraying may be carried out each time for a certain spraying duration, for example a spraying duration in the range between 1 second and 10 minutes, such as a spraying duration of approximately one minute. After each spraying action, i.e. when the spraying duration has ended, the spraying may be paused for a certain pause duration, for example a pause duration in the range between 1 second and 10 minutes, such as a pause duration of four minutes.

In that sense, a spraying ratio may be defined as the percentage of time during which spraying is carried out. For the above exemplary values, the spraying ratio is one minute for every five minutes, thus being 20%.

In an embodiment, the method comprises the measuring of a feed mass flow rate of water fed towards the spraying device and the measuring of a discharge mass flow rate of water pumped out of the root compartment, after being sprayed onto the plant roots inside the root compartment. The feed mass flow rate and the discharge mass flow rate may differ from each other, which difference may represent the overall amount of water absorbed by the plant roots.

In a further embodiment, the supply of water towards the spraying device, i.e. the feed mass flow rate, may be controlled on the basis of the difference between the feed and discharge mass flow rates. As such, the supply of water towards the plant roots may be minimized to the amount of water that is actually absorbed by the plant roots. This may reduce spillage of water and may reduce the consumption of energy required for pumping the water towards the spraying device.

In an embodiment of the method, the root compartment is substantially opaque, in particular substantially opaque for light in the visible and ultraviolet spectrum.

It was found by the present inventors that an opaque root compartment, i.e. a root compartment that has a relatively low light level, offers improved conditions for the formation of new roots and the growth of existing roots. In particular in the absence of light, i.e. in darkness, the formation of new roots may be enhanced. When the bottom portion of the stem is lowered into the root compartment, i.e. during each step of lowering, it thus not only becomes subjected to the supply of water, but also to an environment that promotes growth of roots. In that sense, the formation of new roots is promoted, but also the growth of the remaining root portion, e.g. after pruning, is promoted, so that the root portion can return faster towards its initial root volume.

In an embodiment of the method, the step of pruning comprises the cutting of the bottom end of the root portion over a height substantially equal to the height over which the plant has been lowered. According to this embodiment, the overall length of the root portion remains substantially the same before and after lowering and root pruning. Hence, the bottom portion of the stem is lowered into the root compartment for a certain height, but this then equal to the height of the part of the root portion that is cut off.

In an embodiment of the method, the root portion is tightly surrounded at least partially by a circumferential root growth promotor. Preferably, the root growth promotor is supported exclusively under influence of a circumferentially outward clamping force of the root portion acting on the root growth promotor.

This root growth promotor surrounds the root portion of the plant and is configured to form a sideward confinement for the growth of the root portion. The root portion, i.e. thus including the bottom portion of the stem that is lowered into the root compartment, is sidewardly, e.g. in horizontal directions, surrounded by the root growth promotor. The root portion is in contact with the root growth promotor, whereas the root growth promotor may be spaced apart from the stem. The root growth promotor is thereby configured to physically block the sideways growth of roots. Hence, the roots of plants will typically develop less when they encounter a physical barrier. As such, it may be prevented that dominant root zones of the root portion with grow excessively large and that, by means of the root pruning, a constant volume of roots is removed each time, minimizing shocks and stress for the plant, and resulting in a better plant balance and production.

Instead, the plant will develop and grow roots at locations where the roots are not, e.g. not yet confined by the root growth promotor. Accordingly, the plant will have an extra motivation to grow roots at the bottom portion of the stem that has just been lowered into the root compartment, since the root growth promotor is spaced away from the stem, thereby not yet blocking the growth of roots.

Apart from facilitating an even growth of roots, the root growth promotor may confine the root portion of the plant, to avoid that root portions of multiple different plants may become entangled, for example during movement of the plants.

As a further benefit, the root growth promotor may form a fixed reference point in certain processing stations for the plants, for example a scanning station and/or a harvesting station. In such a station, the plant may be held by its root growth promotor, which are uniform for each of the plants, to allow for more reliable gripping as compared to when the root portion itself were to be gripped.

The root growth promotor may preferably hang on the root portion, thereby not being supported by any other means. This hanging may be caused by the contact between the root portion and the root growth promotor. Hence, with the roots growing against the root growth promotor, they may, e.g. altogether, exert a pressure on the root growth promotor. This pressure may be aligned in radially outward, e.g. horizontal, directions, seen with respect to the vertical direction in which the stem extends. Accordingly, this pressure may effect outward clamping of the root growth promotor, thereby ensuring full support of the root growth promotor.

Alternatively, for hanging the root growth promotor on the root portion, the root growth promotor may comprise an annular clamping flap at a top end, for example a conical flap made of a flexible material, like rubber. The clamping flap may be, under influence of gravity acting onto the root growth promotor, configured to clamp a part of the root portion, for example the bottom portion of the former stem of the plant. However, the clamping flap may allow upward movement of the root growth promotor, i.e. when countering gravitational forces, to allow for convenient shifting of the root growth promotor.

According to this embodiment, the root growth promotor may be free of other suspension means. In this way, the plant not only supports its own weight by being suspended, but additionally also supports the weight of the root growth promotor.

In a further embodiment of the method, the root growth promotor comprises a circumferential wall, which defines a through passage along an elongate axis and which comprises one or more side apertures, which provide access towards the through passage in one or more transverse directions perpendicular to the elongate axis.

According to this embodiment, the circumferential wall may form the physical barrier for preventing growth of the roots, whereas the side apertures in the circumferential wall may allow for the passage of water and nutrients, so that those can be received by the roots that are confined in the root growth promotor.

In an alternative or additional embodiment of the method, the circumferential wall of the root growth promotor extends along the elongate axis over a length substantially equal to the length of the root portion, i.e. in a vertical direction.

According to this embodiment, substantially the entire root portion is contained in the root growth promotor. As such, the growth of existing roots of the original root portion can be limited, whereas the root growth promotor does allow for the growth of new roots on the bottom portion of the stem, which has just been lowered into the root compartment. Hence, this bottom portion of the stem will also form part of the root portion after lowering and will thus also be confined in the root growth promotor.

In an alternative or additional embodiment of the method, the step of lowering further comprises the upward shifting of the root growth promotor with respect to the plant over a height substantially equal to the height over which the plant has been lowered, so that the bottom portion of the stem in the root compartment becomes at least partially surrounded by the root growth promotor.

Each time the plant is lowered, according to this embodiment, the root growth promotor is shifted upward. In this way, the bottom portion of the stem, which has just been lowered into the root compartment and which will form part of the root portion, will become surrounded by the root growth promotor to eventually confine the growth of roots.

As a result of the upward shifting of the root growth promotor, a bottom end of the root portion may become exposed below the root growth promotor. This bottom end, however, forms no practical use anymore and is typically being pruned before or after the lowering of the plant.

In an embodiment, the method further comprises the step of scanning, for example optical scanning, one or more parameters of the plant. The scanning may be done autonomously to gain knowledge about the physical state of the plant and may, for example, be done optically by means of one or more cameras.

Typically parameters that can be scanned may be, but are not limited to, length of the plant, size and/or number of leaves, presence and/or ripeness of produce etc.

In an embodiment of the method, the steps of lowering, root pruning, scanning and/or harvesting are carried out at one or more respective stations, e.g. a respective lowering station, root pruning station, scanning station and/or harvesting station, which stations are located remote from a cultivation location. This cultivation location may be the location at which the plants are located when they are allowed to grow, e.g. at the root compartment. The stations are, according to this embodiment, not located at the cultivation location, but for example at a different location in the greenhouse, such as a central processing location.

According to this embodiment, the method further comprises the steps of:
moving the plant from the cultivation location to the stations, prior to the steps of lowering, root pruning, scanning and/or harvesting, and
moving the plant from the stations to the cultivation location, after the steps of lowering, root pruning, scanning and/or harvesting.

To enable the scanning, lowering, root pruning and/or harvesting to be carried out at the remote stations, the plants are transported thereto and are transported back to the cultivation location afterwards. This transportation is enabled, because the plants are freely suspended vertically by their own weight. Hence, the plants only hang straight below a support structure and have free hanging root portions that are not located in voluminous and heavy plant pots or substrates.

In a further embodiment of the method, the plant is suspended from a movable support structure, which for example comprises one or more wheels or rollers to engage with a rail system. Alternatively, the movable support structure may comprise a suspended chain, from which the plants can be suspended, or may be any other system that allows the plants to be suspended in a movable manner.

The movable support structure is configured to move, for example actively, by means of internal actuators or motors, or passively, by means of an external actuator, such as being attached to a driven conveyor or chain. The movable support structure can be moved simply, for example via a rail system, trolley and/or motorized carriage, whereas the plant's root portion will move out of the root compartment and whereas the plant will thus follow movements of the support structure.

In an embodiment, the step of suspending the plant concerns the suspending of a seedling, in the absence of growth medium. According to this embodiment, plants are cultivated in the absence of growth medium around the root portion throughout the entire life cycle of the plants. This differs from the existing cultivation methods, in which plant seedlings are initially cultivated in soil and in which the soil is only removed at a later stage. This may provide the benefit that the method according to the present embodiment may result in fewer waste, since no soil or other growth medium is utilized. Furthermore, the present method may provide for less stress for the plants, since they are no longer subjected to a change in conditions, i.e. from cultivation in soil to soilless cultivation

According to a second aspect, the present invention provides a cultivation assembly for carrying out the method according to any of the preceding embodiments, comprising:
a support structure, configured to suspend the stem of the plant,
a substantially enclosed root compartment, configured to receive the root portion of the plant, and
a watering device, arranged at least partially in the root compartment and configured to provide the water, e.g. with nutrients and/or oxygen to the plant, i.e. to the root portion.

The cultivation assembly may be provided in a greenhouse, so that it may be used to cultivate plants, like tomato plants, bell pepper plants, cucumber plants and/or eggplants, in greenhouse cultivation, and plants the like that are able to form roots on stem parts under certain conditions like humidity, low light level and oxygen level.

The support structure is configured to hold the plant, e.g. to hold the plant substantially stationary during its growth. Part of the plant, i.e. the stem, is thereby held exposed to light, whereas another part of the plant, e.g. the root portion, is hanging in the root compartment. The root compartment is thereby located below the support structure.

The watering device is arranged inside the root compartment and is configured to supply water to the plant's roots. This supply of nutrients may involve supplying water, i.e. combined with nutrients, oxygen, fertilizer, hormones and/or pesticides etc., so that they can be absorbed by the roots. The watering device may be configured to spray water with nutrients onto the root portion or may be configured to submerge, in particular to temporarily submerge, the root portion in a body of water with nutrients.

The cultivation assembly according to the present invention may comprise one or more of the features illustrated herein in view of the cultivation method according to the present invention and/or may have one or more of the benefits illustrated herein in relation to the present cultivation method.

In an embodiment of the cultivation assembly, the support structure comprises at least one clamp, configured to clamp the stem of the plant. The at least one clamp may be fixedly connected to a frame part of the support structure or may, for example, be attached to a rope or chain that is suspended for supporting the plant.

The support structure may for example comprise two or three clamps, located above one another, which are together configured to hold the top portion of the plant.

The benefit of having clamps is that they may securely hold the plant, as the entire weight of the plant is hanging from them, while it is avoided that a flow of nutrients in the plant becomes blocked. Furthermore, the clamps may be relatively convenient to attach, for example by a human worker or a robot, so that the suspending of a plant can be carried out efficiently.

In an embodiment of the cultivation assembly, the root compartment is substantially opaque, in particular substantially opaque for light in the visible and ultraviolet spectrum.

It was found by the present inventors that an opaque root compartment, i.e. a root compartment that has a relatively low light level, offers improved conditions for the formation of new roots and the growth of existing roots. In particular in the absence of light, i.e. in darkness, the formation of new roots may be enhanced. When the bottom portion of the stem is lowered into the root compartment, i.e. during each step of lowering, it thus not only becomes subjected to the supply of nutrients, but also to an environment that promotes growth of roots. In that sense, the formation of new roots is promoted, but also the growth of the remaining root portion, e.g. after pruning, is promoted, so that the root portion can return faster towards its initial size.

In an embodiment of the cultivation assembly, the root compartment comprises a substantially enclosed gutter, configured to receive root portions of a plurality of plants arranged in a row extending parallel to the gutter.

By means of such a gutter, multiple root portions of multiple different plants can be arranged in the same root compartment, i.e. in the same gutter. The plants may thereto be suspended in rows, for example perpendicular to an aisle of a greenhouse, which rows are each parallel to a respective gutter.

The substantially enclosed gutter may comprise a slit at its top, which may be relatively narrow compared to the width of the gutter, i.e. the width perpendicular to the elongate direction of the gutter, through which slit the plants enter the gutter. The benefit of having only a narrow slit is that the climate in the gutter, e.g. the moist climate with a relatively low light level, can be maintained more effective, in order to obtain optimal growing conditions for the roots.

The gutter may be particularly useful when it is desired to move the plants, e.g. through the greenhouse, because the plants may be moved such, for example along the rows, that their root portions are in the gutter for a longer period of time, as compared to when they were each to be held in an individual root compartment for a single plant. In particular, the plant stems may be moved through the slits upon being moved towards a central alley of the greenhouse.

Furthermore, the gutter may provide the benefit over existing cultivation assemblies with a root compartment with discrete top openings in that the positions of the individual plant not need to be accurately defined. Hence, in the existing cultivation assemblies, each plant must be positioned in its own top opening, which fixes the plant positions. By means of the gutter, the plants can be positioned anywhere along the length of the slit. This offers the possibility of being able to adjust the mutual distance between the plant, improving the flexibility of the cultivation assembly, for example allowing different types of plants to be cultivated and to cultivate plants at different densities, i.e. mutual distances.

In an embodiment of the cultivation assembly, the watering device comprises a spraying device that projects into the root compartment, configured to spray nutrients, e.g. onto the root portion in the root compartment. The spraying of the root portion may be sufficient for subjecting the root portion to its required amount of water and nutrients and may make it obsolete to submerge the root portion in water.

A benefit of the spraying is that a mist of water may become present in the root compartment and that the humidity inside the root compartment may be higher than in the surroundings, i.e. the surroundings of the plant's stem, outside the root compartment. Furthermore, the spraying may make the root portion wet and may provide oxygen to the root portion. This all may promote the formation of new roots at the bottom portion of the plant stem, which has just been lowered into the root compartment, and may also promote the growth of existing roots of the root portion.

In a further embodiment, each spraying device is configured to spray multiple plants in the root compartment. The method according to this embodiment can rely on fewer spraying nozzles than in the existing cultivation method. Hence, according to the present embodiment, the plant positions not necessarily need to be defined at discrete positions. Instead, the plant positions may vary and each spraying device may have a relatively wide spraying range, thereby being able to spray multiple different plants inside the root compartment.

The present embodiment may be especially beneficial when the root compartment is embodied as a gutter with a slit at its top. The gutter allows plants to be positioned anywhere over the length of the slit and does not require each plant to be positioned in its own top opening. Furthermore, the present embodiment offers the benefit that the plants do not need to be accurately positioned in front of a spraying device, as in the prior art, since each spraying device is able to cover multiple plants, as it has a large spraying range.

In an embodiment, the cultivation assembly is configured to measure a feed mass flow rate of water fed towards the spraying device and to measure a discharge mass flow rate of water pumped out of the root compartment, after being sprayed onto the plant roots inside the root compartment. The feed mass flow rate and the discharge mass flow rate may differ from each other, which difference may represent the overall amount of water absorbed by the plant roots.

In a further embodiment, the cultivation assembly may be configured to control the supply of water towards the spraying device, i.e. the feed mass flow rate, on the basis of the difference between the feed and discharge mass flow rates. As such, the supply of water towards the plant roots may be minimized to the amount of water that is actually absorbed by the plant roots. This may reduce spillage of water and may reduce the consumption of energy required for pumping the water towards the spraying device.

In an embodiment, the cultivation assembly further comprises a plant, for example a tomato plant, bell pepper plant, cucumber plant and/or an eggplant, or a plants the like that is able to form roots on stem parts under certain conditions like humidity, low light level and oxygen level, comprising a stem and a root portion,

wherein the plant freely hangs from the support structure by a top portion of the stem and wherein the root portion hangs from the stem, e.g. freely hangs from the stem, in the root compartment in the absence of growth medium.

Opposed to existing cultivation assemblies, the plants in the cultivation assembly according to the present embodiment are configured to be freely suspended. This implies that substantially the entire plant hangs under the influence of gravitational forces, i.e. thus hanging substantially vertical, without resting at least partially horizontally and preferably without the roots being supported separately by a root compartment.

The plant is held at a top portion and is configured to fully support its own weight. Hence, all parts of the plant below the top portion, e.g. a middle and bottom portion of the stem and at least part of the root portion, are fully hanging from the top portion, without being substantially supported otherwise in the vertical direction. However, the plant not needs to be held exclusively at the top portion and may for example be held additionally at a middle portion and/or a bottom portion.

The root portion of the plant is suspended in the root compartment, preferably being freely suspended, so that also the root portion is fully suspended from the stem, without being supported otherwise. The root compartment is substantially empty, which implies that the plant's roots are not arranged in any type of growth medium, like soil, rock wool or the like, but instead that the plant's roots freely hang in the air inside the root compartment, possibly inside a root growth promotor. The root portion of the plant may hang vertically in the root compartment However, in case the length of the root portion is relatively long compared to the height of the root compartment, the bottom portion of the root portion may be tied up to the plant stem, to prevent the root portion from contacting the bottom of the root compartment.

In an embodiment, the cultivation assembly further comprises a root growth promotor, configured to surround the root portion at least partially, and the root growth promotor is preferably configured to be supported exclusively under influence of a circumferentially outward clamping force of the root portion acting on the root growth promotor.

This root growth promotor is configured to surround the root portion of the plant and is configured to form a sideward confinement for the growth of the root portion. The root portion, i.e. thus including the bottom portion of the stem that is lowered into the root compartment, is configured to be sidewardly, e.g. in horizontal directions, surrounded by the root growth promotor. The root portion is configured to be in contact with the root growth promotor, whereas the root growth promotor may be spaced apart from the stem. The root growth promotor is thereby configured to physically block the sideways growth of roots. Hence, the roots of plants will typically develop less when they encounter a physical barrier. As such, it may be prevented that dominant root zones of the root portion with grow excessively large and that, by means of the root pruning, a constant volume of roots is removed each time, minimizing shocks and stress for the plant, and resulting in a better plant balance and production.

Instead, the plant will develop and grow roots at locations where the roots are not, e.g. not yet confined by the root growth promotor. Accordingly, the plant will have an extra motivation to grow roots at the bottom portion of the stem that has just been lowered into the root compartment, since the root growth promotor is spaced away from the stem, thereby not yet blocking the growth of roots.

Apart from facilitating an even growth of roots, the root growth promotor may confine the root portion of the plant, to avoid that root portions of multiple different plants may become entangled, for example during movement of the plants.

As a further benefit, the root growth promotor may form a fixed reference point in certain processing stations for the plants, for example a scanning station and/or a harvesting station. In such a station, the plant may be held by its root growth promotor, which are uniform for each of the plants, to allow for more reliable gripping as compared to when the root portion itself were to be gripped.

The root growth promotor may preferably be configured to hang on the root portion, thereby not being supported by any other means. This hanging may be caused by the contact between the root portion and the root growth promotor. Hence, with the roots growing against the root growth promotor, they may, e.g. altogether, exert a pressure on the root growth promotor. This pressure may be aligned in radially outward, e.g. horizontal, directions, seen with respect to the vertical direction in which the stem extends. Accordingly, this pressure may effect outward clamping of the root growth promotor, thereby ensuring full support of the root growth promotor.

Alternatively, for hanging the root growth promotor on the root portion, the root growth promotor may comprise an annular clamping flap at a top end, for example a conical flap made of a flexible material, like rubber. The clamping flap may be, under influence of gravity acting onto the root growth promotor, configured to clamp part of the root portion, for example the bottom portion of the former stem of the plant. However, the clamping flap may allow upward movement of the root growth promotor, i.e. when countering gravitational forces, to allow for convenient shifting of the root growth promotor.

According to this embodiment, the root growth promotor may be free of other suspension means. In this way, the plant is not only configured to support its own weight by being suspended, but additionally also supports the weight of the root growth promotor.

In a further embodiment of the cultivation assembly, the root growth promotor comprises a circumferential wall, which defines a through passage along an elongate axis and which comprises one or more side apertures, which provide access towards the through passage in one or more transverse directions perpendicular to the elongate axis.

According to this embodiment, the circumferential wall may form the physical barrier for preventing growth of the roots, whereas the side apertures in the circumferential wall may allow for the passage of water and nutrients, so that those can be received by the roots that are confined in the root growth promotor.

A further benefit of the side apertures is that, when the root growth promotor is slided upward, any roots that have been growing out of the side apertures are either folded inward in the root growth promotor, which thereby further fill the root growth promotor, or are pruned off automatically. Both options may be desirable for different types of plants and whether the first portion or the second option occurs may depend on the shape of apertures. For example, rounded shapes may fold roots inward, whereas narrow vertical slits may cut off roots when the root growth promotor is slid upward.

The circumferential wall may, seen along the elongate axis, comprise a cross-section. This cross-section may have an enclosed, hollow shape. For example, the circumferential wall may comprise a rectangular, for example square shape, or may comprise a rounded, for example circular shape.

Similarly, the side apertures may have shape, seen in the transverse, e.g. horizontal direction. The side apertures may, for example, have a rectangular, for example square shape, or may comprise a rounded, for example circular shape.

Furthermore, the size and/or shape of the side apertures of the root growth promotor may vary over its length in vertical direction, i.e. its height. In an upper part of the root growth promotor, the side apertures may be relatively large to allow more water and nutrients to enter top roots of the root portion. At an opposed bottom part of the root growth promotor, the side apertures may be relatively narrow to stop root growth more effectively.

In an advantageous embodiment, the side apertures may be embodied as slits that have a rectangular shape, being substantially elongate along the elongate axis of the root growth promotor, i.e. in the vertical direction, and being relatively narrow in a perpendicular, i.e. horizontal, direction.

In an embodiment, the cultivation assembly further comprises a lowering station, root pruning station, scanning station and/or harvesting station, respectively configured to lower the plant relative to the support structure, to cut-off part of the root portion, to scan one or more parameters of the plant and to harvest produce from the plant.

In a further embodiment of the cultivation assembly, the lowering station, root pruning station, scanning station and/or harvesting station are located remote from a cultivation location. This cultivation location may be the location at which the plants are located when they are allowed to grow, e.g. at the root compartment. The stations are, according to this embodiment, not located at the cultivation location, but for example at a different location in the greenhouse, such as a central processing location.

According to this embodiment of the cultivation assembly, the support structure is configured to move the plant between the cultivation location and one or more of the stations.

To enable the scanning, lowering, root pruning and/or harvesting to be carried out at the remote stations, the plants are transported thereto and are transported back to the cultivation location afterwards. This transportation is enabled, because the plants are freely suspended vertically by their own weight. Hence, the plants only hang straight below the support structure and have free hanging root portions that are not located in voluminous and heavy plant pots or substrates.

In a further embodiment of the cultivation assembly, the support structure is a movable support structure that comprises one or more wheels or rollers to engage with a rail system. Alternatively, the movable support structure may comprise a suspended chain, to which hook systems can be attached and from which the plants can be suspended, or may be any other system that allows the plants to be suspended in a movable manner.

The movable support structure is configured to move, for example actively, by means of internal actuators or motors, or passively, by means of an external actuator, such as being attached to a driven conveyor or chain. The movable support structure can be moved simply, for example via a rail system, trolley and/or motorized carriage, whereas the plant's root portion will move out of the root compartment and whereas the plant will thus follow movements of the support structure.

According to a further aspect, the present invention provides a root growth promotor for a cultivation assembly as disclosed herein. The root growth promotor according to the present invention may comprise one or more of the features illustrated herein in view of the root growth promotor described in relation to the cultivation method and/or cultivation assembly according to the present invention and/or may have one or more of the benefits illustrated herein in relation to the present cultivation method and/or cultivation assembly.

According to yet another aspect, the present invention provides an indoor farm, in particular a greenhouse, for cultivating plants comprising the cultivation assembly as disclosed herein, wherein the support structure is attached to a roof construction of the greenhouse. With the support structure being attached to the roof construction, for example forming part of a rail system attached to the roof construction, the plants are effectively configured to be suspended from the roof construction.

In an embodiment of the indoor farm, the roof construction comprises a movable support structure, e.g. extending at least between the cultivation location and one or more of the lowering station, root pruning station, scanning station and/or harvesting station, and the movable support structure for example comprising one or more wheels or rollers that are configured to be supported by and to roll over a rail system or comprising a suspended chain to which hook systems are attached.

### BRIEF DESCRIPTION OF DRAWINGS

Further characteristics of the invention will be explained below, with reference to embodiments, which are displayed in the appended drawings, in which:

FIGS. 1-4 schematically depict steps of an embodiment of the cultivation method according to the present invention,

FIG. 5 schematically depicts an embodiment of the cultivation assembly according to the present invention,

FIGS. 6A-6E schematically depict various embodiments of the root growth promotor according to the present invention,

FIGS. 7A-7C schematically depict embodiments of part of the indoor farm according to the present invention, and

FIGS. 8A and 8B schematically depict embodiments of a greenhouse according to the present invention.

Throughout the figures, the same reference numerals are used to refer to corresponding components or to components that have a corresponding function.

### DETAILED DESCRIPTION OF EMBODIMENTS

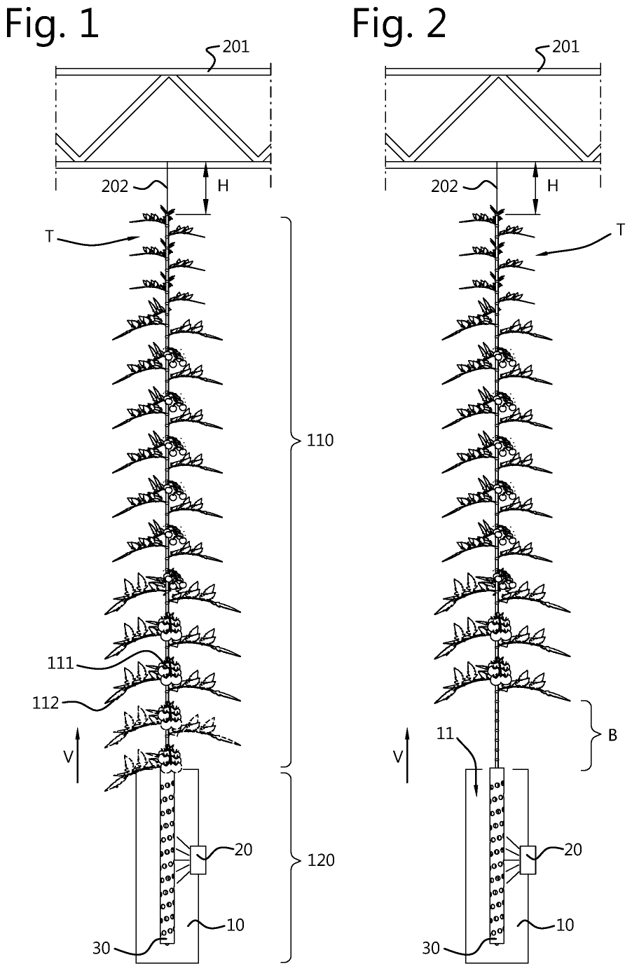

FIGS. 1-4 schematically depict steps of an embodiment of the cultivation method according to the present invention. The present method is a carried out to cultivate plants, to which is referred with reference numeral 100.

The plants 100 are configured to grow continuously and substantially straight and parallel to a vertical direction V. In the present embodiment of the method, the plants 100 are suspended in a greenhouse 200 from a roof structure 201 by means of a support structure that is embodied as a wire, e.g. a metal wire 202.

The plants 100 cultivated by means of the present method comprise a stem 110 and a root portion 120. The stem 110 of the plant 100 is defined as the part of the plant 100 that is substantially free of roots 121 and rather has produce 111 and leaves 112 attached to it. The root portion 120 is accordingly may defined as the part of the plant 100 comprising roots 121. According to the present method, roots 121 are being formed on a former bottom portion B of the stem that previously contained produce 111 and leaves 112.

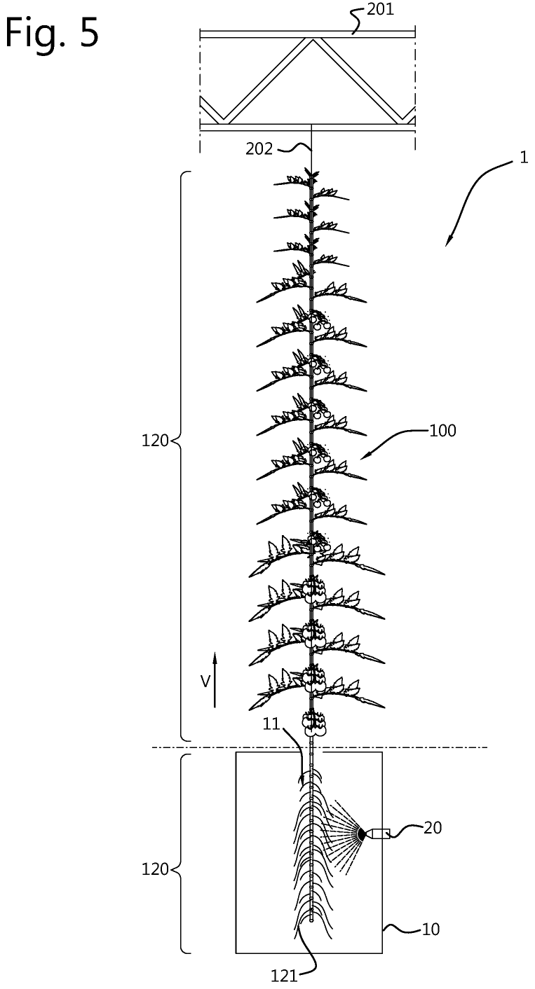

It is best shown in FIG. 5 that the root portion 120 of the plant 100 is located in a root compartment 10 when the method is carried out, whereas the stem 110 is located above the root compartment 10.

The plant 100 cultivated in the present embodiment of the method is a tomato plant 100, which typically has a stem 110 that is relatively long compared to the length of the root portion 120 of the plant 100. Alternative plants suitable to be cultivated by means of the present method are bell pepper plants, cucumber plants and/or eggplants, and plants the like that are able to form roots on stem parts under certain conditions like humidity, low light level and oxygen level.

According to the present method, the plant 100 is freely suspended, which implies that the entire plant 100 hangs under the influence of gravitational forces that work in the downward vertical direction. The plant 100 hangs substantially vertical, without resting horizontally and without the roots 121 being supported separately in the root compartment 10.

The plant 100 is held at a top portion T, in particular held at two holding points at a top portion T of its stem 110. In the present embodiment, the top portion T of the stem 110 is defined as the upper 25% of the stem 110 in terms of height.

The plant 100 fully supports its own weight, since all parts of the plant 100 below the top portion T are fully hanging from the top portion T, without being substantially supported otherwise in the vertical direction V.

The root portion 120 of the plant 100 is suspended in the root compartment 10, which root compartment 10 is substantially closed-off from the surroundings. In the embodiment of FIGS. 1-4, the root compartment 10 only comprises a single opening 11 at a top end through which the plant 100 extends. The root compartment 10 is substantially empty and the roots 121 of the plant 100 are not arranged in any type of growth medium.

The root compartment 10 is substantially opaque for light in the visible and ultraviolet spectrum. This provides that the interior of the root compartment 10 has a relatively low light level, offers improved conditions for the formation of new roots and the growth of existing roots. In particular in the absence of light, i.e. in darkness, the formation of new roots may be enhanced.

In the root compartment 10, water with nutrients is supplied to the roots 121 of the plant 100 by means of a spraying device 20. The spraying device 20 is configured to spray water with nutrients onto the root portion 120. The spraying relies on droplets with various sizes, varying from a small droplet size, in which the spraying effectively becomes misting or generation of a fog, to a large droplet size, for example to effect a certain degree of direct penetration of the plant 100 with water.

It is shown best in FIG. 5 that, in an embodiment of the cultivation assembly 1 according to the present invention, the spraying device 20 is provided inside the root compartment 10 and that the spraying device 20 is configured to spray water onto the root portion 120.

In the present embodiment of the method, the spraying of water is not carried out continuously. Instead, the spraying is carried out intermittently for a spraying duration during certain discrete spraying intervals. The spraying is carried out for a spraying duration of approximately one minute. After each spraying action, i.e. when the spraying duration has ended, the spraying is paused for a pause duration of four minutes. As such, a spraying ratio is one minute for every five minutes, thus being 20%.

It is shown in FIGS. 1-4 that the root portion 120 of the plant 100 is tightly surrounded by a circumferential root growth promotor 30. The root growth promotor 30 surrounds the root portion 120 of the plant 100 and is configured to form a sideward confinement for the growth of roots 121 of the root portion 120. The root portion 120 is in contact with the root growth promotor 30 that is configured to physically block the sideways growth of roots 121. Instead, the plant 100 will develop and grow roots 121 at locations where the roots 121 are not yet confined by the root growth promotor 30.

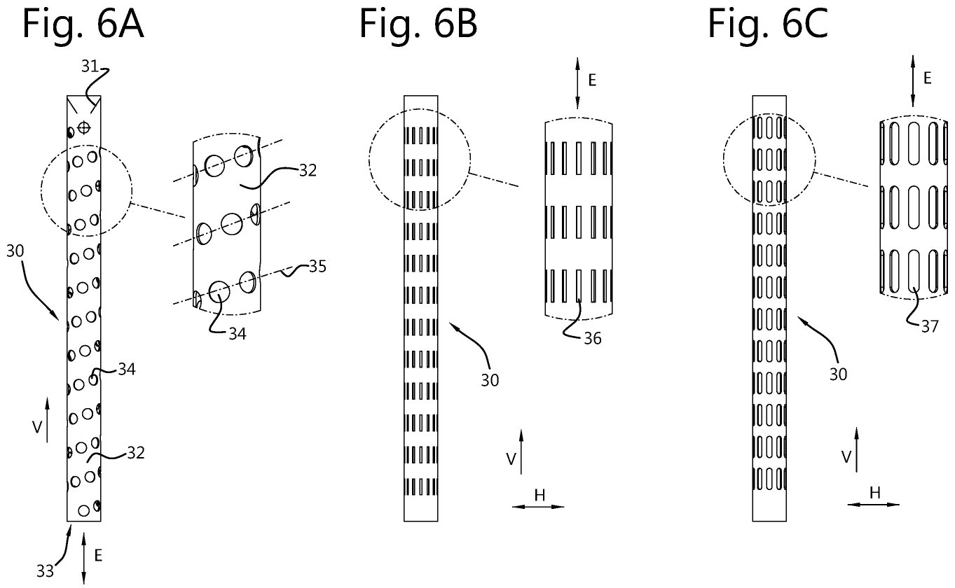

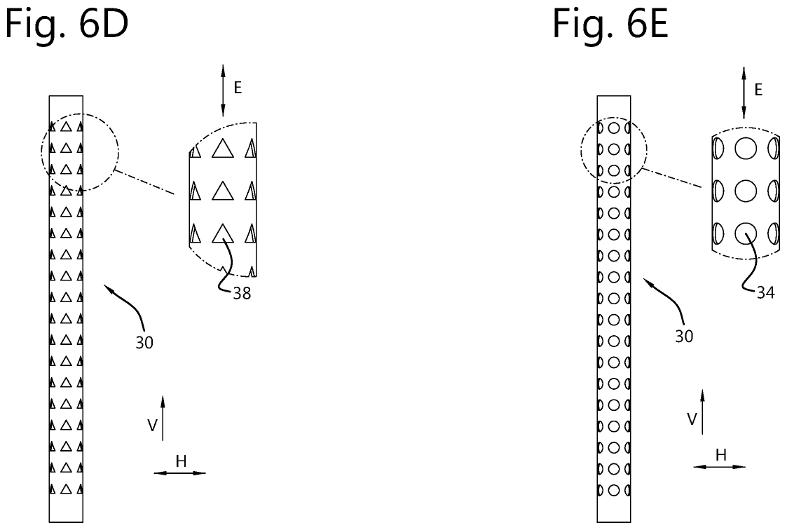

The root growth promotor 30 hangs on the root portion 120 and is not supported by any other means. This hanging is at least partly be caused by the contact between the root portion 120 and the root growth promotor 30, i.e. by a pressure exerted on the root growth promotor 30 by the root portion 120. Further details of the root growth promotor 30 are discussed later, in relation to the various embodiments of the root growth promotor 30 shown in FIGS. 6A-6E.

In the method step shown in FIG. 1, the plant 100 has been allowed to grow under influence of the nutrients and under exposure of light that enters the greenhouse 200 through the glass roof. During growth, the plant 100 forms a newly-grown portion N of stem 110 above the top portion T, as is best shown in FIG. 4. FIG. 4 represents the plant 100 prior to growth and prior to the state thereof displayed in FIG. 1.

It is shown in FIG. 4 that, after growth of the plant 100, the original top portion T becomes a former top portion and that the newly-grown portion N then becomes the top portion. The growth of the plant 100 further concerns growth of the root portion 120 inside the root compartment 20 and concerns growth of the produce 111 and leaves 112.

After having allowed the plant 100 to grow, the method comprises the step of harvesting produce 111 and leaves 112 from the stem 110, as is shown in FIG. 2. During the harvesting, the produce 111 and the leaves 112 are cut from the bottom portion B of the stem 110, i.e. the part of the stem 110 located right above the root portion 120 and the root compartment 10. The remaining bottom portion B thus essentially only consists of part of the stem 110, no longer comprising any produce or leaves.

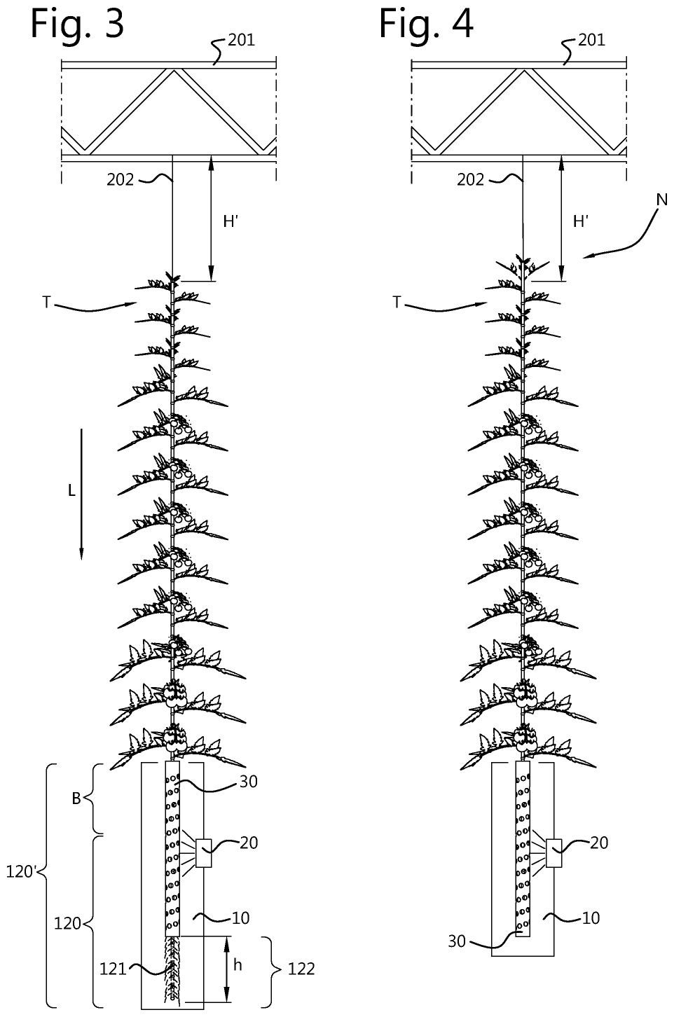

After having allowed the plant 100 to grow, the length of the stem 110 will be increased. To hold the stem 110 length substantially constant, the plant 100 is lowered after it has grown to a certain extent. The lowering, represented in FIG. 3 by means of downward arrow L, implies that the suspension of the plant 100 relative to the greenhouse roof structure 201 is changed, so that the plant 100 will hang lower.

Hence, prior to lowering, shown in FIGS. 1 and 2, the plant 100 was suspended at a height H below the greenhouse roof structure 201. After lowering, shown in FIGS. 3 and 4, the plant 100 was suspended at a lower height H′ below the greenhouse roof structure 201. Accordingly, the plant 100 has been lowered over a lowering height h, which is equal to the lower height H′ minus the original height H.

During lowering, the clamps clamping the stem 110 of the plant 100 at the top portion T are released. After lowering, the clamps are clamped again, so that at least one of the clamps is configured to clamp the newly-grown portion N of the stem 110, i.e. above the original top portion T. The plant 100 is now suspended at least partially by its newly-grown portion N, which newly-grown portion N then, by definition, becomes the new top portion of the stem.

After the step of lowering, the bottom portion B of the stem 110 becomes freely hanging in the root compartment 10 as well. Hence, the root compartment 10 remains substantially stationary and will not be lowered together with the plant 100.

The step of lowering further comprises the upward shifting of the root growth promotor 30 with respect to the plant over a height h substantially equal to the height h over which the plant 100 has been lowered. As such, the bottom portion B of the stem 110 in the root compartment 10 becomes surrounded by the root growth promotor 30 as well. The root growth promotor 30 is thereby configured to achieve that the plant 100 will develop and grow roots 121 at locations where the roots 121 are not yet confined by the root growth promotor 30. Accordingly, the plant 100 will have an extra motivation to grow roots 121 at the bottom portion B of the stem 110 that has just been lowered into the root compartment 10, since the root growth promotor 30 is spaced away from the stem 110, thereby not yet blocking the growth of roots at the bottom portion B.

The original bottom portion B of the stem 110, which now becomes arranged in the root compartment 10, will be subjected to the water with the nutrients and oxygen that is sprayed by the spraying device 20.

After lowering, the bottom portion B of the stem 100 and the original root portion 120 together become the new root portion 120′ and a new bottom portion B′ of the stem 110 is defined just above the root compartment 10.

As a result of the upward shifting of the root growth promotor 30, a bottom end 122 of the root portion 130 becomes exposed below the root growth promotor 30. This bottom end 122 forms no practical use anymore, since new roots 121 are formed at the bottom end B of the stem 110. According to the present embodiment of the method, the root portion 120 is pruned at the bottom end 122 after the lowering of the plant 100.

The pruning is carried out to prevent the root portion 122 from becoming too large inside the root compartment 10. After pruning, the length of the new root portion 120′ is substantially the same as the length of the original root portion 120 before lowering.

The pruning comprises the cutting of the bottom end 122 of the root portion 120 over a height h substantially equal to the height over which the plant has been lowered, i.e. equal to the lower height H′ minus the original height H.

Finally, these steps are repeated, so that after the step in FIG. 4, the step in FIG. 1 follows again. During repeating, the plant 100 is allowed to grow while spaying the water with the spraying device 20, followed by lowering and root pruning.

FIG. 5 shows an embodiment of the cultivation assembly 1 according to the present invention, which is similar to the cultivation assembly shown in FIGS. 1-4 to illustrate the embodiment of the cultivation method shown in those figures. Compared to FIGS. 1-4, the cultivation assembly 1 in FIG. 5 comprises a root portion 120 that is freely suspended in the root compartment 10 in the absence of a root promotor, thereby clearly showing the roots 121 of the plant 100.

FIGS. 6A-6E display various embodiments of the root growth promotor 30 according to the present invention. These root growth promotors 30 are suitable to be included in the cultivation assembly 1 that is shown in FIGS. 1-4 to illustrate the embodiment of the cultivation method shown in those figures or in the cultivation assembly 1 shown in FIG. 5.

All embodiments of the root growth promotors 30 in FIGS. 6A-6E are configured to surround the root portion 120 of the plant 100 and are configured to be supported under influence of a circumferentially outward clamping force of the root portion 120 acting on the root growth promotor 30. The root growth promotor 30 is configured to form a sideward confinement for the growth of the root portion 120. The root growth promotor 30 is thereby configured to physically block the sideways growth of roots 121.

The root growth promotor 30 is configured to form a fixed reference point in processing stations for the plants 100, for example in a scanning station and/or a harvesting station. In such a station, the plant 100 may further be held by its root growth promotor 30. The respective root growth promotors 30 are uniform for each of the plants 100, to allow for more reliable gripping as compared to when the root portion 120 itself were to be gripped.

The root growth promotor 30 is configured to hang on the root portion 120, thereby not being supported by any other external means, for example not being attached to the root compartment 10. This hanging may be caused by the contact between the root portion 120 and the root growth promotor 30, i.e. by a pressure of the root portion 120 exerted on the root growth promotor 30.

The present root growth promotor 30 may comprise an conical annular clamping flap 31 at a top end, made of a flexible material, like rubber. The clamping flap 31, which is shown in FIG. 6A, is, under influence of gravity acting onto the root growth promotor 30, configured to clamp the bottom portion B of the stem 110 of the plant 100. As a result of its flexibility and downward conicity, the clamping flap 31 is configured to allow upward movement of the root growth promotor 30 relative to the stem 110 of the plant 100.

All embodiments of the root growth promotor 30 shown in FIGS. 6A-6E comprise a circumferential wall 32, which defines a through passage 33 an elongate axis E. Seen along the elongate axis E, all embodiments of the root growth promotor 30 shown in FIGS. 6A-6E comprise a circumferential wall 32 with a hollow cross-section that has a circular shape.

The root growth promotors 30 each comprise a plurality of side apertures 34 in the circumferential wall 32, which provide access towards the through passage 33 in one or more horizontal directions H perpendicular to the elongate axis E. The side apertures 34 in the circumferential wall 32 are configured to allow for the passage of water and nutrients to the roots 121 of the root portion 120 confined in the through passage 33.

The embodiments of the root growth promotor 30 in FIGS. 6A-6E differ in terms of size and shape of the side apertures 34. In the embodiment of FIG. 6A, the side apertures 34 have a circular shape and are mutually arranged along a helical lines 35 about the circumference of the circumferential wall 32, as is best shown in the enlarged detail in FIG. 6A.

The root growth promotor 30 in FIG. 6B comprises rectangular side apertures 36, e.g. rectangular slits, which are substantially elongate parallel to the elongate axis E, i.e. elongate in the vertical direction V and relatively narrow in a horizontal direction H perpendicular to the vertical direction V. The rectangular side apertures 36 are arranged in straight horizontal rows, which extend about the circumference of the circumferential wall 32 in the horizontal direction H.

The root growth promotor 30 in FIG. 6C also comprises rectangular side apertures 37, but these are wider in the horizontal direction H, compared to the side apertures 36 in FIG. 6B. Furthermore, the side apertures 37 in the root growth promotor 30 of FIG. 6C have rounded upper edges and lower edges, which may be beneficial in cutting possible roots 121 that protrude through the side apertures 37, upon moving the root growth promotor 30 upward.

In the embodiment of the root growth promotor 30 in FIG. 6D, side apertures 38 are provided that have a triangular shape. The triangular side apertures 37 are arranged parallel to the horizontal direction H in straight horizontal rows about the circumference of the circumferential wall 32 as well.

In the embodiment of the root growth promotor 30 in FIG. 6E, the circumferential wall 32 comprises the circular side apertures 34. Opposed to circular side apertures 34 in FIG. 6A, are the circular side apertures 34 in the embodiment of FIG. 6E arranged parallel to the horizontal direction H in straight horizontal rows about the circumference of the circumferential wall 32.

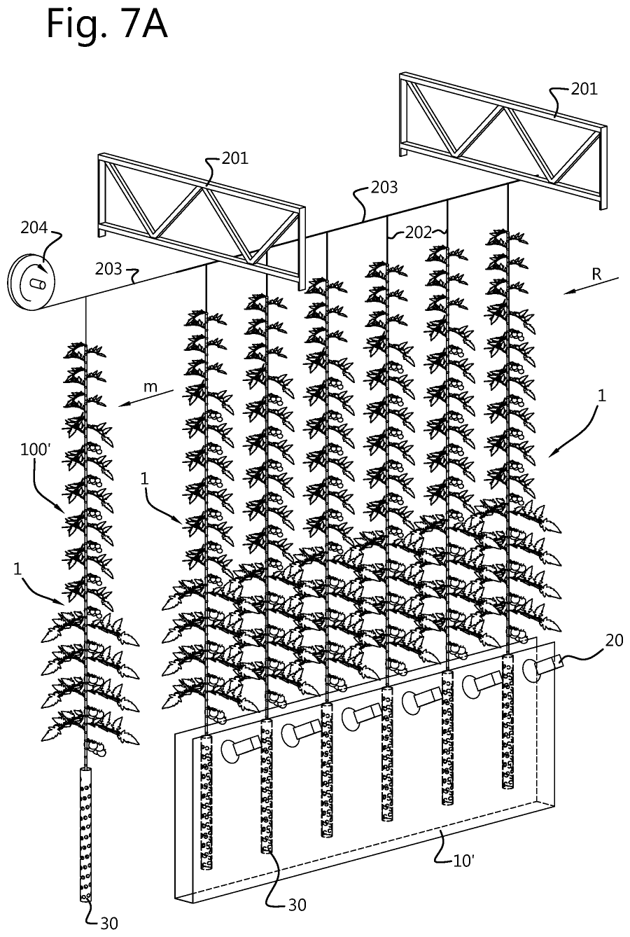

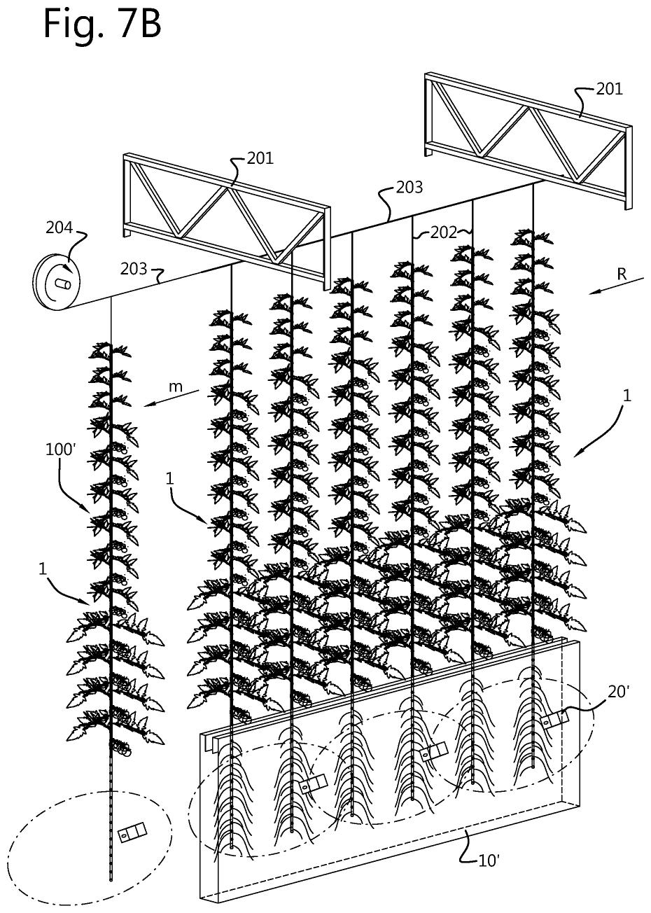

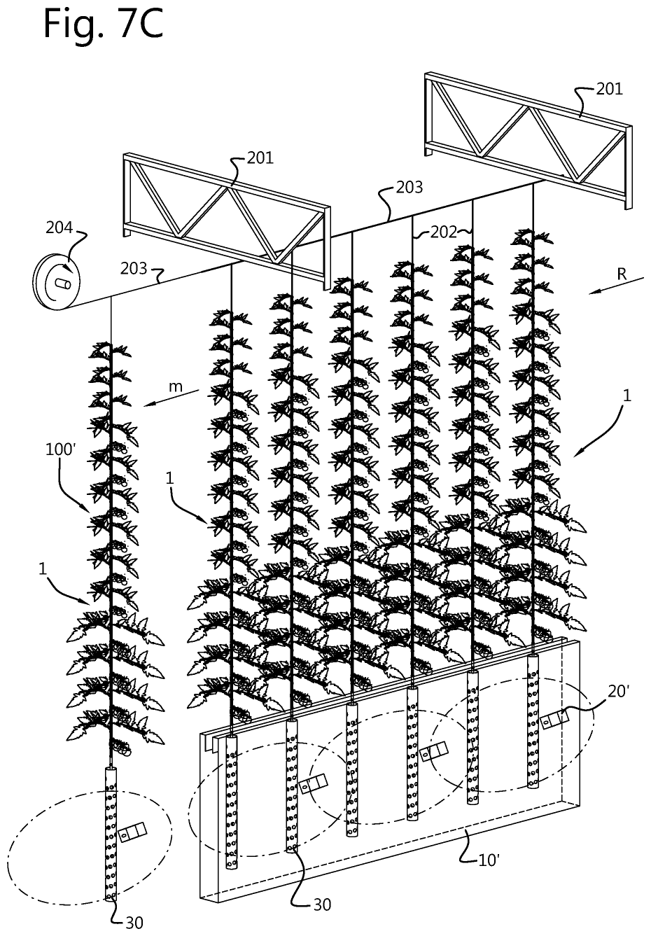

FIGS. 7A-7C schematically depict embodiments of parts of the indoor farm according to the present invention. The indoor farm is embodied as a greenhouse 200 that comprises a greenhouse roof construction 201. The greenhouse 200 is configured to cultivate plants 100, e.g. tomato plants in the present embodiment, and comprises a plurality of the cultivation assemblies 1 shown in FIG. 5.

The roof construction 201 of the greenhouse 200 is configured to fully support the plants 100, so that the plants 100 freely hang from the roof construction 201. The greenhouse 200 comprises a central support line 203, extending substantially perpendicular to the roof construction 201. Each of the cultivation assemblies 1 comprises a wire, e.g. a metal wire 202, which is attached to the central support line 203 and which each is configured to support a respective plant 100.

The cultivation assemblies 1 are arranged next to each other so that the plants 100 are arranged in a row R underneath the central support wire 203. The cultivation assemblies 1 share a single root compartment, which is embodied as an enclosed root gutter 10′. The root gutter 10′ extends substantially parallel to the central support wire 203, so that all plants 100 in the row R of plants have their respective root portions 120 located in root growth promotors 30 in the root gutter 10′.

The root gutter 10′ is substantially enclosed and comprises a slit 11′ at its top. The slit 11′ receives the plants 100, so that the root portions 120 of all plants 100 in the row R enter the root gutter 10′. Accordingly, the root gutter 10′ comprises multiple spraying devices 20, which are spread over the length of the root gutter 10′.

The central support wire 203 is configured to allow movement of the wires 202 and thus of the plants 100, so that the plants 100 can be slid along the row R. The root portions 120 of the plants 100 thereby move through the root gutter 10′, so that, even during movement of the plants 100, the root portions 120 can remain in the enclosed circumstances of the root gutter 10′ and can remain being sprayed by the spraying devices 20, whilst being moved through the slit 11′.

The greenhouse 200 further comprises a winch 204, which is associated with the central support wire 203. The winch 204 is configured to transport a mobile plant 100′ through the greenhouse 200, to move the plants 100 from a cultivation location, i.e. in the root gutter 10′, towards one or more processing stations. These processing stations may be one or more of a lowering station, a root pruning station, a scanning station and/or a harvesting station.

The embodiments in FIGS. 7A and 7B differ from each other, in that the plants 100 in the embodiment in FIG. 7A each have a root growth promotor 30 around their root portions and that a dedicated spraying device 20 is provided for each of the plants 100. In the embodiment in FIG. 7B, instead, the root portions of the plants 100 are not provided with root growth promotors, but are freely exposed in the root gutter 10′.

Furthermore, fewer spraying devices 20′ are provided in the embodiment of FIG. 7B, compared to FIG. 7A. However, each spraying device 20′ is able to spray over a wider spraying range. Each spraying device 20′ is thereby able to provide water and nutrients to multiple different plants 100, instead of only a single one.

In the embodiment in FIG. 7C, the plants 100 are provided with root growth promotors 30, similar as in FIG. 7A. However, the embodiment of FIG. 7C comprises the wide-range spraying devices 20′ that are present in the embodiment in FIG. 7B, instead of the individual spraying devices. Therefore, the position of the spraying devices 20′ is not linked to the position of the plants 100.

As an alternative to the central support wire 203 and the winch 204, the roof construction may comprise a rail, e.g. extending at least between the cultivation location and the processing stations. A movable support structure may then be provided, comprising one or more wheels or rollers, and configured to be supported by and to roll over the rail.

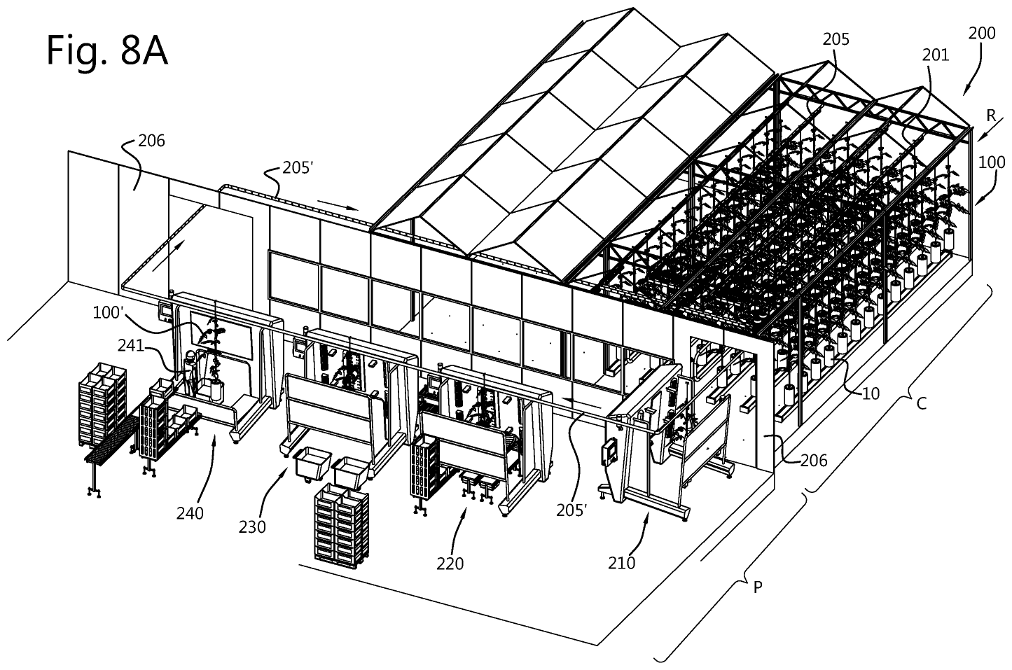

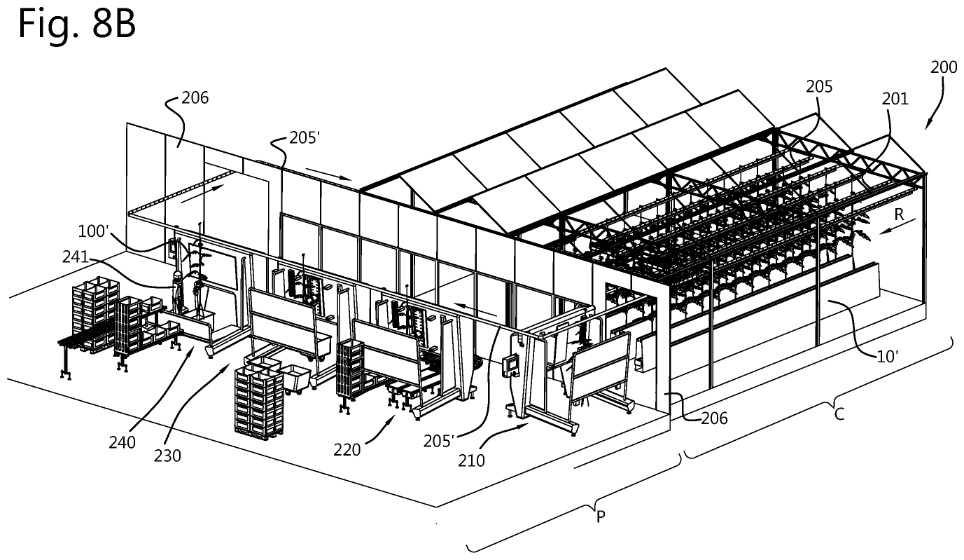

FIGS. 8A and 8B schematically depict embodiments of the greenhouse 200 according to the present invention. The greenhouse 200 comprises a cultivation location C in which a plurality of rows R of plants 100 are located. Each of the plants 100 has its root portion arranged in a respective root compartment 10.

The greenhouse 200 comprises a roof construction 201 onto which a plurality of chains 205 are attached, for example extending through the greenhouse 200 in a chain loop 205′. At the cultivation location C, each row R of plants 100 comprises its own chain 205 extending over the root compartments 10. Each of the plants 100 is suspended from a hook system attached to the chain 205, to move the plants 100 through the greenhouse 200 by circulating the chain 205.

The greenhouse 200 further comprises a centralized processing location P, which is separated from the cultivation location C by a greenhouse wall 206. The chain loop 205′, extends from the cultivation location C to the processing location P to define a transportation path for mobile plants 100′. The transportation path is represented by means of arrows in FIG. 8

The chain loop 205′ passes along a plurality of processing stations, provided in the processing location P and located remote from the cultivation location C. Upon passing the processing stations, the mobile plants 100′ may undergo a certain treatment in the processing location P, which, in the prior art, took place in the cultivation location.

After entering the processing location P, each plant 100′ first moves along a scanning station 210 upon moving along the transportation path. The scanning station 210 is configured to scan, i.e. by means of optical scanning, one or more parameters of the plant 100′. The scanning is done autonomously by means of multiple cameras, in order to gain knowledge about the physical state of the plant 100′. Typically parameters are being scanned may be, but are not limited to, length of the plant 100′, size and/or number of leaves 112 and presence and/or ripeness of produce 111.

Next, the plant 100′ passes along a harvesting station 220 on its transportation path. The harvesting station 220 is configured to harvest produce 111 from the plant 100′, in particular to harvest produce 111 that is detected in the scanning station 210 to be sufficiently ripened.

After the harvesting station 220, the plant 100′ passes along a deleaf station 230, which is configured to remove the lowermost leaves 112 from the plant 100′, i.e. to harvest leaves 112 at points along the plant's stem where produce 111 has been harvested.

Finally, before returning to the cultivation location C, the plant 100′ passes along a human worker station 240. At the human worker station 240, the plant 100′ may be lowered by a human worker 241, to allow the plant to grow further. Additionally, the human worker 241 at the human worker station 240 may be configured to prune a bottom end of the root portion of the plant 100′ before the plant 100′ is returned to the cultivation location C along the transportation path. Furthermore, the human worker 241 at the human worker station 240 may remove leaves 112 and produce 11 from the plant 100 that was, by mistake or error, not removed at the harvesting station 220.

The embodiments in FIGS. 8A and 8B differ in that the plants 100 in the embodiment in FIG. 8A are each arranged in their own root compartment 10, which is embodied as an individual vertical tube for each of the plants. In the embodiment of FIG. 8B, the root compartment is embodied as an enclosed root gutter 10′, having a slit 11′ at its top, so that the plants 100 can be moved along the length of the slit 11′ and that the spacing between adjacent plants 100 can be adjusted.

1.-30. (canceled)

31. A method of cultivating plants, comprising the steps of:
suspending a plant, which plant comprises a stem and a root portion,
wherein step of suspending comprises freely hanging the plant by a top portion of the stem and wherein the root portion freely hangs from the stem, in a substantially enclosed root compartment in the absence of growth medium,
providing water in the root compartment,
lowering the plant after having allowed the plant to grow,
wherein the step of lowering comprises the re-suspending of the plant by a newly-grown portion of the stem, and wherein, after the step of lowering, a bottom portion of the stem becomes freely hanging in the root compartment, to allow new roots to grow on the bottom portion of the stem in the root compartment,
pruning the root portion at least partially at a bottom end thereof, and
repeating the steps of lowering and root pruning after each time the plant has been allowed to grow.

32. The method according to claim 31, wherein the step of suspending further comprises the clamping of the top portion of the stem with at least one clamp of a support structure.

33. The method according to claim 31, wherein the step of providing nutrients comprises the spraying of nutrients onto the plant in the root compartment.

34. The method according to claim 31, wherein the root compartment is substantially opaque.

35. The method according to claim 31, wherein the root portion is tightly surrounded at least partially by a circumferential root growth promotor.

36. The method according to claim 35, wherein the root growth promotor comprises a circumferential wall, which defines a through passage along an elongate axis and which comprises one or more side apertures, which provide access towards the through passage in one or more transverse directions perpendicular to the elongate axis.

37. The method according to claim 35, wherein the circumferential wall of the root growth promotor extends along the elongate axis over a length substantially equal to the length of the root portion.

38. The method according to claim 35, wherein the step of lowering further comprises the upward shifting of the root growth promotor with respect to the plant over a height substantially equal to the height over which the plant has been lowered, so that the bottom portion of the stem in the root compartment becomes at least partially surrounded by the root growth promotor.

39. The method according to claim 31, further comprising the step of scanning one or more parameters of the plant.

40. The method according to claim 31, wherein the steps of lowering, root pruning, scanning and harvesting are carried out at one or more respective stations, located remote from a cultivation location,
the method further comprising the steps of:
moving the plant from the cultivation location to the stations, prior to the steps of lowering, root pruning, scanning and harvesting, and
moving the plant from the stations to the cultivation location, after the steps of lowering, root pruning, scanning and harvesting.

41. The method according to claim 40, wherein the plant is suspended from a movable support structure.

42. A cultivation assembly for carrying out the method according to claim 31, comprising:
a support structure, configured to suspend the stem of the plant,
a substantially enclosed root compartment, configured to receive the root portion of the plant, and
a watering device, arranged at least partially in the root compartment and configured to provide the water.

43. The cultivation assembly according to claim 42, wherein the root compartment comprises a substantially enclosed gutter, configured to receive root portions of a plurality of plants arranged in a row extending parallel to the gutter.

44. The cultivation assembly according to claim 42, further comprising a root growth promotor, configured to tightly surround the root portion at least partially.

45. The cultivation assembly according to claim 44, wherein the root growth promotor comprises a circumferential wall, which defines a through passage along an elongate axis and which comprises one or more side apertures, which provide access towards the through passage in one or more transverse directions perpendicular to the elongate axis.

46. The cultivation assembly according to claim 42, further comprising a lowering station, a root pruning station, a scanning station and a harvesting station, respectively configured to lower the plant relative to the support structure, to cut-off part of the root portion, to scan one or more parameters of the plant and to harvest produce from the plant.

47. A root growth promotor for a cultivation assembly according to claim 42.

48. An indoor farm for cultivating plants comprising the cultivation assembly according to claim 42, comprising a roof construction, wherein the support structure is attached to the roof construction.

49. The indoor farm according to claim 48, wherein the roof construction comprises a movable support structure.
